(19) United States
(12) Patent Application Publication
(10) Pub. No.: US 2017/0154313 A1
(43) Pub. Date: Jun. 1, 2017

(54) PERSONALIZED JOB POSTING PRESENTATION BASED ON MEMBER DATA

(71) Applicant: LinkedIn Corporation, Sunnyvale, CA (US)

(72) Inventors: Anthony Duane Duerr, Castro Valley, CA (US); David Hardtke, Oakland, CA (US); Dan Shapero, Palo Alto, CA (US); Jeremy Lwanga, San Francisco, CA (US); Kaushik Rangadurai, Sunnyvale, CA (US); Kunal Mukesh Cholera, Mountain View, CA (US); Vidya Chandrasekaran, Mountain View, CA (US); Bo Zhao, Redwood City, CA (US); Caleb Timothy Johnson, Santa Clara, CA (US); Jiuling Wang, San Jose, CA (US); Lauren Miller Kelly, San Francisco, CA (US); Adrien Lazzaro, Belmont, CA (US)

(21) Appl. No.: 15/364,773

(22) Filed: Nov. 30, 2016

Related U.S. Application Data
(60) Provisional application No. 62/261,003, filed on Nov. 30, 2015.

(51) Int. Cl. G06Q 10/10; G06F 17/30; G06Q 10/06

(52) U.S. Cl. CPC G06Q 10/1053; G06Q 10/063112; G06F 17/30312; G06F 17/3053; G06F 17/30554

(57) ABSTRACT

Techniques for presenting a personalized job posting are described. A job publisher can access member data of a first member from a member database and a plurality of job postings from a job database. A job score for each job posting in the plurality of job postings can be calculated based on the profile data of the first member and the job data for each job posting. Additionally, a relevant job posting for the first member can be determined based on the calculated job score for each job posting in the plurality of job postings. Moreover, a second member for the relevant job posting can be selected based the social graph data of the first member and the job data for the relevant job posting. Furthermore, a presentation of the relevant job posting can be on a display of a device of the first member.

### PRIORITY CLAIM

This application claims priority under 35 U.S.C. 119(e) to U.S. Provisional Patent Application Ser. No. 62/261,003, filed Nov. 30, 2015, which is incorporated herein by reference in its entirety.

### TECHNICAL FIELD

The subject matter disclosed herein generally relates to data processing for a job search in an online social networking service and_{;} more particularly, to a job search experience personalized for a user based on the user's member data.

### BACKGROUND

An online social networking service can maintain information on members, companies, organizations, employees, and employers. The online social network that is part of the online social networking service may maintain profile pages of members, which can include education information, employment information, and location information about a specific member. Additionally, the online social network can store information about a member's relationships with other members of the online social network. Moreover, an employer can list a job posting, and a member may want to search a job using the online social networking service. Often, some useful information to connect a potential employer with a member may be missing or otherwise unavailable to the member.

### BRIEF DESCRIPTION OF THE DRAWINGS

Some embodiments are illustrated by way of example and not limitation in the figures of the accompanying drawings.

FIG. 1 is a network diagram illustrating a network environment suitable for an online social network, according to some example embodiments.

FIG. 2 is a block diagram illustrating various components of an online social network, according to some example embodiments.

FIG. 3 is a flowchart illustrating operations of the online social network in performing a method for a personalized presentation of a relevant job posting based on member data and job data, according to some example embodiments.

FIG. 4 is a flowchart illustrating operations of the online social network in performing another method for a personalized presentation of a relevant job posting based on member data and job data, according to some example embodiments.

FIG. 5 is a user interface for presenting a relevant job to a member, according to some example embodiments.

FIG. 6 is a user interface for presenting a personalized job posting with an insight to a member, according to some example embodiments.

FIG. 7 is another user interface for presenting a personalized job posting with an insight to a member, according to some example embodiments.

FIG. 8 is a user interface for suggested contacts associated with a job posting, according to some example embodiments.

FIG. 9 is a block diagram illustrating components of a machine, according to some example embodiments, able to read instructions from a machine-readable medium and perform any one or more of the methodologies discussed herein.

### DETAILED DESCRIPTION

Example methods and systems are directed to techniques for displaying suggestions (e.g., insights) improve a job seeking experience for a member of an online social networking service. More specifically, the present disclosure relates to methods, systems, and computer program products for determining a member's connection to a job posting, and determining member-specific benefits for applying to the job posting.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In some instances, an online social network can present job postings to a member. Often, the job postings are generic and not tailored to the specific member. According to some embodiments, a job publisher in the online social network can modify and tailor a job posting for the specific member. For example, based on accessed member data of the specific member, the job posting is modified and tailored to the specific member. The job publisher can use algorithms for curating the job posting based on the accessed member data.

The member profile page of a member can include a location, education information, employer information, first-degree connections, and an industry associated with the member. The member profile page can include a list of skills that the member possesses. In some instances, other members in the online social network can endorse a skill of the member using an endorsement or recommend the member by posting a recommendation on the member profile page.

The job publisher can access the member data from the member profile page to modify the job posting for the specific member. For example, the modified job posting can include first-degree connections that work at the employer associated with the job posting. In another example, the modified job posting can include the members or a numerical indication of how many members currently working at the employer that went to the same school as the specific member. In another example, the modified job posting can include the members or number of members currently working at the employer that previously worked at the same company as the specific member.

Additionally, the job publisher can present (e.g., highlight) a selected job posting. For example, the job posting can be selected when the job posting is determined to be a hidden gem job posting, a trending job posting, a high growth job posting, and so on. The online social networking service can include a job classifier to classify job postings for the job publisher to select.

For example, the job classifier can classify a job posting as a hidden gem. A hidden gem job posting includes a job posting with a low number of applicants that is a good fit for the specific member. The job posting has a low number of applicants when the number of members that have applied for the job posting is below a predetermined number (e.g., two, five, or ten). Additionally, the job posting is a good fit for the specific member when a job score associated with the job posting and the specific member is above a threshold value. The job score can be based on the job description from the job posting and the accessed member data of the specific member.

Moreover, the job classifier can classify a job posting as a trending job posting. A trending job posting includes a job posting which has a high number of views over a certain timeframe by members of the online social networking service. The job classifier can access member activity data and job posting data to determine the number of views the job posting has received over a certain timeframe. When the number of views (e.g., 10, 20, 50, 100, or 200) for the job posting over a certain timeframe (e.g., one day) is above a predetermined threshold, then the job classifier classifies the job posting as trending. For example, when a job posting has received more than 100 views in a day, then the job posting can be classified as trending.

In another example, the job classifier can classify a job posting as a trending job posting when the employer associated with the job posting is a trending company. The online social networking service stores company data (e.g., rate of views for the company page, number of followers, number of job applicants for previous job postings, number of new hires) for companies listed on the online social network service. The job classifier can determine that the employer is trending based on accessed company data for the employer. For example, the employer is determined to be trending when the rate views for the company page are above a predetermined threshold. Based on the determination, the job classifier can classify all job postings from the trending employer as a trending job posting.

Furthermore, the job classifier can classify a job posting as a high growth job posting when the employer associated with the job posting is a high growth company. As previously mentioned, the online social networking service stores company data for companies listed on the online social network service. The job classifier can determine that the employer is a high growth company based on the accessed company data. For example, the employer is determined to be high growth when the number of new hires for the employer is above a threshold. Based on the determination, the job classifier can classify all job postings from the high growth employer as a high growth job posting.

in some current implementations, algorithms for displaying insights related to a job posting can be determined based on member data. Insights can be based on information derived from the member's social network, the company's social network, or the relationship between the member and the company.

In some instances, an insight can include a first-degree or second-degree connection that is related to the job posting. For example, a first-degree connection that works at the company for the job opening can be displayed as an insight on a personalized job posting for the user. The user can contact the first-degree connection, via the social network system, to submit a referral to a hiring manager for the job posting. Additionally, an insight can include a benefit to the user for applying to the job posting. A benefit can be based on the company trending, the job trending, the member expressing interest in the company, the member's activity on the online social networking service, or the job posting being a hidden gem.

Using the insights, the online social networking service can personalize the job searching experience for a member. For example, benefits (e.g., commute to the job, salary, career growth opportunity) that are specific to the member can be displayed to the member as reasons for applying to a particular job posting. Additionally, advantages that the member (e.g., specific skill set of the member) has over other candidates for the particular job posting can be displayed as an insight. Furthermore, connections in the member's social network can be displayed for the member to contact regarding the job posting.

In some instances, the online social networking service can have a job classifier for the user. The job classifier can categorize job posting based on interest in the company, interest in the industry, interest in the job description, location, salary, and so on. The job classifier can further categorize job posting based on the member data, such as determining commute time, determining potential salary range for the user based on the user's experience, and so on.

Furthermore, the job publisher can publish a personalized job posting for a member based on a job score calculator. The job score calculator can rank job postings based on the member data, the company data_{;} or the relationship between the member and the company. Using the job score calculator to score and rank job postings based on the member data, the job publisher can present job postings determined to be a good fit for the member. For example, the job postings with the highest job scores (e.g., top three) can be presented to member. Additionally, the presented top job postings can include one or more insights for the user. Furthermore, the presented top job postings can include information regarding the reasons for selecting the particular job posting(s) for the member.

The job score calculator can rank job postings using a plurality of search algorithms. In some instance, the job score calculator can receive user input from the member to determine the search strategy. The user input can determine a weighting factor for different search variables (e.g., prioritized based on location, salary, job description, educational requirement). Additionally, the job score calculator can dynamically interleave the different search results from the plurality of search algorithms. For example, the top search result from the plurality of search algorithms can be presented to the user. When the top search result of two different search algorithms is for the same job posting, that job posting can be presented first. Furthermore, the job score calculator can receive a vote from the user to determine the preferred search algorithm of the user.

Techniques described herein allow for the determination of a job posting's relevance for a specific member based on a job score, generating a personalized job posting based on information from the job posting, and presentating the personalized job posting to the specific member. The job score can be based on the profile data, the internal data, the third-party data, and the social graph data of the member and the company.

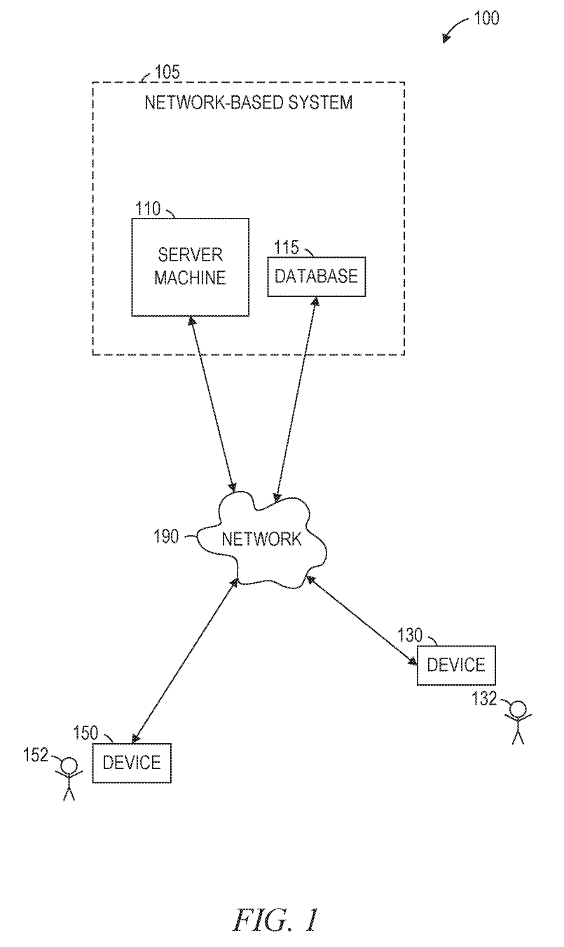

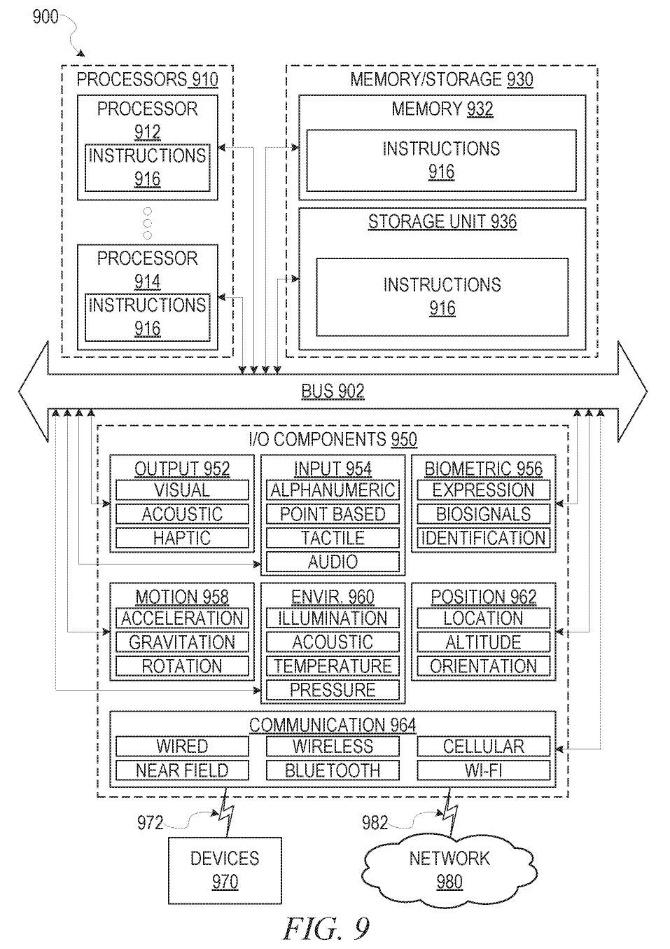

FIG. 1 is a network diagram illustrating a network environment 100 suitable for an online social network service, according to some example embodiments. The network environment 100 includes a server machine 110, a database 115, a first device 130 for a first user 132 (e.g., first member), and a second device 150 for a second user 152 (e.g., second member), all communicatively coupled to each other via a network 190. The server machine 110 and the database 115 may form all or part of a network-based system 105 (e.g., a cloud-based server system configured to provide one or more services to the devices 130 and 150). The database 115 can store, but is not limited to storing, member data, company data, education data, social graph data, member activity data, and job data for the online social network service. In some instances, the database 115 can include a plurality of databases (e.g., a first database to store profile data, a second database to store social data, a third database to store job data). The server machine 110, the first device 130, and the second device 150 may each be implemented in a computer system, in whole or in part, as described below with respect to FIG. 9.

Also shown in FIG. 1 are the users 132 and 152. One or both of the users 132 and 152 may be a human user (e.g., member of the online social network), a machine user (e.g., a computer configured by a software program to interact with the device 130 or 150), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device a smart watch or smart glasses) belonging to the user 132. Likewise, the user 152 is not part of the network environment 100, but is associated with the device 150. As an example, the device 150 may be a desktop computer, a vehicle computer, a tablet computer, a navigational device, a portable media device, a smartphone, or a wearable device (e.g., a smart watch or smart glasses) belonging to the user 152, In some instances, the user 132 can be the member searching for a job posting.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a Wi-Fi network or WiMAX network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

Any of the machines, databases, or devices described herein may be implemented in a computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 9. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices described herein may be combined into a single machine, database, or device, and the functions described herein for any single machine, database, or device may be subdivided among multiple machines, databases, or devices.

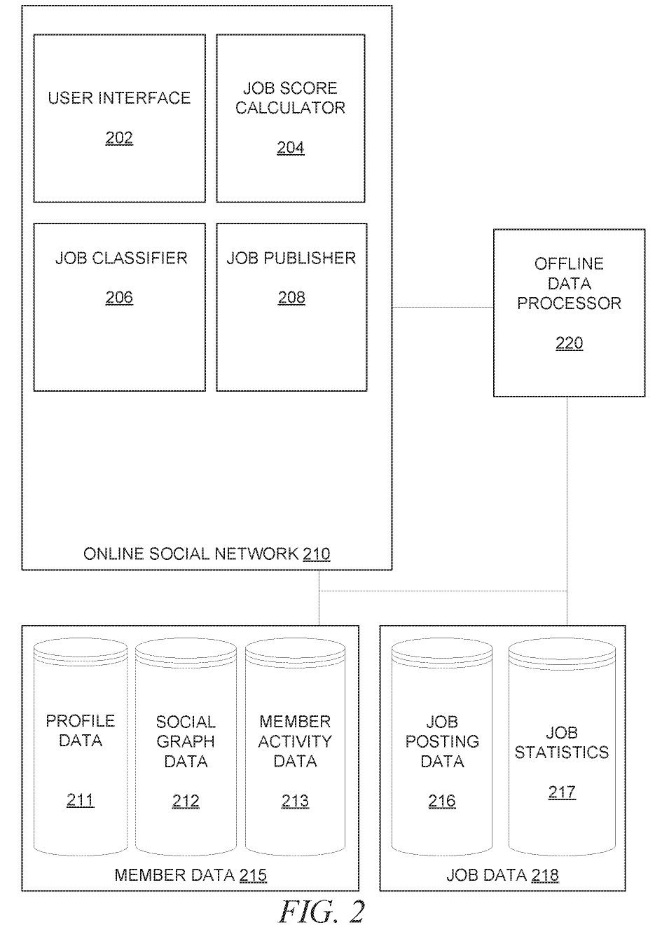

FIG. 2 is a block diagram illustrating components of an online social network 210, according to some example embodiments. The online social network 210 is an example of a network-based system 105 of FIG. 1. The online social network 210 can include a user interface 202, an job score calculator 204, a job classifier 206, and a job publisher 208, all configured to communicate with each other (e.g., via a bus, shared memory, or a switch). Additionally, the online social network 210 can communicate with the database 115 of FIG. 1, such as a database storing member data 215 and job data 218. In some instances, the member data 215 can be stored in a first database and the job data 218 can be stored in a second database. The server machine 110 can access the member data 215 and the job data 218 using the network 190.

The member data 215 can include profile data 211, social graph data 212, and member activity data 213. The job data 218 can include job posting data 216 and job statistics 217. Using the member data 215 and the job data 218, the job score of a job posting for a specific member can be determined. In some instances, some of the processing of the data for the determination can be performed by an offline data processor 220 on a periodic basis (e.g., nightly) in order to return faster search results.

The profile data 211 can be used to determine the job score of a job posting for a specific member. For instance, when a user registers to become a member of the online social network 210, the member is prompted to provide a variety of personal and employment information that may be displayed in a member's profile page. Such information is commonly referred to as profile data 211. The profile data 211 that is commonly requested and displayed as part of a member's profile includes the member's age, birthdate, gender, interests, contact information, residential address, home town and/or state, spouse's and/or family members' names, educational background (e.g., schools, majors, matriculation and/or graduation dates, etc.), employment history, office location, skills, professional organizations, and so on. In some embodiments, the profile data 211 may include the various skills that each member has indicated he or she possesses. Additionally, the profile data 211 may include skills of a member that have been endorsed by another member.

Additionally, the profile data 211 can include information commonly included in a professional resume or curriculum vitae, such as information about a person's education, the company at which a person is employed, the location of the employer, an industry in which a person is employed, a job title or function, an employment history, skills possessed by a person, professional organizations of which a person is a member, and so on.

For example, the profile data 211 may include the various skills that each member has indicated he or she possesses. Additionally, the profile data 211 may include an endorsement. The endorsement can be a skill for which a member has been endorsed in the profile data 211. Additionally, a recommendation of a member can be received from another member. The job score calculator 204 can calculate a job score for a job posting by comparing the job requirements in the job posting with the profile data 211 of the member. For example, the job score increases if the job requires an engineering degree, and the profile data 211 of the member lists a degree in engineering.

Additionally, online social network 210 services provide their users with a mechanism for defining their relationships with other people. This digital representation of real-world relationships is frequently referred to as a social graph, which may be stored in the social graph data 212.

In some instances, the social graph data 212 can be based on a entity's presence within the online social network 210 service. For example, consistent with some embodiments, a social graph is implemented with a specialized graph data structure in which various entities (e.g., people, companies, schools. government institutions, non-profits, and other organizations) are represented as nodes connected by edges, where the edges have different types representing the various associations and/or relationships between the different entities.

Furthermore, the social graph data 212 may be maintained by a third-party social network service. For example, users can indicate a relationship or association with a variety of real-world entities and/or objects. Typically, user input is captured when a user interacts with a particular graphical user interface element, such as a button, which is generally presented in connection with the particular entity or object and frequently labelled in some meaningful way (e.g., “like,” “+1,” “follow”).

The member activity data 213 can include members' interactions with the various applications, services, and content made available via the online social network 210, and the members' behavior (e.g., content viewed, links selected, etc.) may be used to determine a job score. For example, the job score of a job posting for an employer increases if the member has previously viewed the company page of the employer.

In addition to hosting a vast amount of member data 215, an online social network 210 service can maintain job data 218. The job data 218 includes job posting data 216 and job statistics 217. The online social network 210 may provide a broad range of other applications and services that allow members the opportunity to share and receive information, often customized to the interests of the members. In some embodiments, members may be able to self-organize into groups, or interest groups, organized around subject matter or a topic of interest. In some embodiments, the online social network 210 may host various job listings providing details of job openings with various organizations.

The job posting data 216 includes a plurality of job postings. Each job posting can contain a job title, a job description, desired skills, an employer, and a location. In some instances, the job posting can include contact information for a hiring manager, and a salary range received from the hiring manager.

The job statistics 217 can include metrics for a particular job posting. The metrics can include the page views the particular job posting has received over a certain timeframe. Additionally, the metrics can include the number of applicants that have applied to the job posting, the number of applicants that have applied to another job posting of the employer, the page views of the employer's company page. The job statistics 217 can also include standardized job information that has been derived or inferred from the job description of the job posting. The standardized job information can include salary information (e.g., salary range) and commuting information. The salary range can be determined by the online social network 210 using crowdsourcing techniques, such as user input of other members having the same job title.

The job score calculator 204 and the job classifier 206 can use the member data 215 and the job data 218 to determine the job score of a job posting for the member. Then the job publisher 208 can use the job score to rank the job posting based on relevance to the member. The relevance can be determined by the job score. Additionally, the job classifier 206 can categorize and further rank job postings based on user inputs received from the member. In some instances, the calculation of future job scores can be modified based on user input about certain job posting preferences. For example, a user can indicate a preference for a specific employer, and therefore the job scores of future job postings by the specific employer are increased.

Furthermore, the online social network 210 can be configured to process data offline or periodically using the offline data processor 220. In some instances, some or the entire job score calculator 204, job classifier 206, or job publisher 208 can be performed by the offline data processor 220. For example, the offline data processor 220 can include large-scale servers, such as Hadoop™ servers, that access the member data 215 and job data 218 periodically (e.g., on a nightly basis) to rank the job postings.

Processing the member data 215 and job data 218, such as determining the job score for a job posting, may be computationally intensive; therefore, due to hardware limitations and to ensure reliable performance of the online social network 210, some determination or calculation by the job score calculator 204, job classifier 206, or job publisher 208 may be done offline. For example, the member data 215 may be processed (e.g., real-time, background/offline) using the job score calculator 204 to determine a job score for a job posting. Additionally, the job publisher 208 can present, to a user 132 (e.g., first member), a job posting that is determined to be relevant to the user 132.

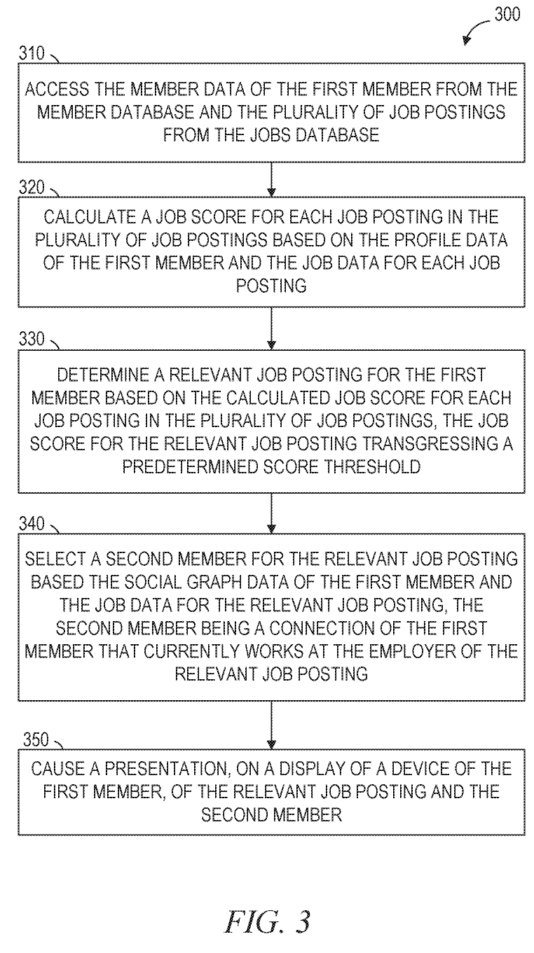

As will be further described with respect to FIG. 3, the job score calculator 204, in conjunction with the user interface 202, the job classifier 206, and the job publisher 208, can present a relevant job posting to the user 132. The relevant job posting can be presented on a newsfeed of the user 132, a profile page of the user 132, or a search result page on the online social network 210.

FIG. 3 is a flowchart illustrating operations of the online social network 210 in performing a method 300 for a personalized presentation of a job posting based on the member data 215 and the job data 218, according to some example embodiments. In some instances, the job data 218 can be included in the member data 215. Operations in the method 300 may be performed by the network-based system 105, using the user interface 202, the job score calculator 204, the job classifier 206, and the job publisher 208 described above with respect to FIG. 2.

As previously mentioned, one or more database stores member data 215 and job data 218. The member data 215 can be stored in a member database. The member data 215 can include profile data 211, social graph data 212, and member activity data 213 of a plurality of members (e.g., a first member, a second member). The profile data 211 include educational information (e.g., degree attained, grades, name of school) and employment information (e.g., current job title, current employer, previous employer, years of experience, industry) of the plurality of members. Additionally, the social graph data 212 includes first-degree connections of each member in the plurality of members.

Furthermore, a job database can store a plurality of job postings, each job posting in the plurality of job postings having job data 218. The job data 218 includes job posting data 216 and job statistics 217.

At operation 310, the job score calculator 204 accesses the member data 215 of the first member from the member database and the plurality of job postings from the job database. The member data 215 includes profile data 211, social graph data 212, and member activity data 213. Additionally, the job score calculator 204 can access job data 218 from the job database. The job data 218 includes job posting data 216 and job statistics 217. The database 115 is an example of the member database and the job database. The member database and the job database can be separate databases. The databases can be accessed by the server machine 110 using the network 190.

At operation 320, the job score calculator 204 calculates a job score for each job posting in the plurality of job postings based on the profile data 211 of the first member and the job data 218 for each job posting. The job score can range from 0 to 100. For example, the job data 218 includes, but is not limited to, a job title, a job description, desired skills, location, desired education, (e.g., desired degree), and expected salary. The profile data 211 includes, but is not limited to, the member's current job title, previous job title, job description, location, years of experience, industry, degrees obtained, skills, and recommendations. The job data 218 and the profile data 211 can be compared to determine the job score. A processor in the server machine 110 can perform the scoring in real-time. In some instances, part of the scoring at operation 320 can be performed offline using the offline data processor 220.

In some instances, the job score can be calculated based on commute time, current salary of the first member, salary range of the job posting, interest of the first member in the employer, industry of the first member, desired degree of the job posting, degrees obtain by the first member, desired skills of the job posting, and skills possessed by the first member.

For example, when the job data 218 includes a job title and the profile data 211 of the first member includes a current title, the job score for each job posting calculated at operation 320 can be based on comparing the job title with the current title. The job score can be above the predetermined threshold described at operation 330 when the current job title of the first member matches the job title of a job posting.

In another example, the job data 218 includes a desired degree for a job posting, and the job score calculated for each job posting is further based on comparing the desired degree for the job posting and a degree obtained by the first member. The job score can be above the predetermined threshold described at operation 330 when the desired degree for the job posting matches the degree obtained by the first member.

In yet another example, the job data 218 includes a salary range for a job posting, and the job score calculated for each job posting at operation 320 is further based on comparing the salary range and the employment information of the first member. Using the employment information of the first member (e.g., current job title, years of experience, industry, current employer, location), a current salary for the first member can be estimated by the job score calculator 204. The job score for a job posting can be above the predetermined threshold at operation 330 when the current salary of the first member is within the salary range of the job posting.

According to some embodiments, the job publisher can receive user input from the first member to determine the search strategy of the job posting. The user input can determine a weighting factor for different search variables (e.g., prioritized based on location, salary, job description, educational requirement) when calculating the job score.

At operation 330, the job classifier 206 determines a relevant job posting for the first member based on the calculated job score for each job posting in the plurality of job postings. The job scores are calculated at operation 320. In some instances, a job posting is determined to be relevant when the job score for the relevant job posting transgresses (e.g., being above, being below) a predetermined score threshold. The predetermined threshold (e.g., 80, 90, 95) can be set by an administrator. In another example, the job posting with the highest job score can be the relevant job posting. A processor in the server machine 110 can perform the determination in real-time.

At operation 340, the job publisher 208 selects a second member for the relevant job posting based the social graph data 212 of the first member and the job data 218 for the relevant job posting. The second member can be a connection (e.g., first-degree connection) of the first member that currently works at the employer of the relevant job posting. The connection can be a first-degree connection, a second-degree connection, or a third-degree connection. A processor in the server machine 110 can perform the selection in real-time.

In some instances, the selection of the second member at operation 340 can be also based on the profile data 211 of the first member. For example, given that the profile data 211 includes educational information, the selection of the second member at operation 340 can be further based on the first member having attended a school that is common with the second member. In another example, given that the profile data 211 includes employment information, the selection of the second member at operation 340 can be further based on the first member having a common employer with the second member.

At operation 350, the user interface 202 is configured to cause a presentation, on a display of a device of the first member, of the relevant job posting and the second member. In some instances, the relevant job posting can be personalized to include information about the second member. The profile picture of the second member can be part of the presentation of the relevant job posting. For example, the first member can contact the second member for referral. A processor in the server machine 110 can cause the presentation at operation 350.

According to some embodiments, the method 300 can further include the job publisher 208 determining an insight associated with the relevant job posting based on the job data 218 for the relevant job posting. Additionally, the relevant job posting can be further personalized to include the insight at operation 350. The insight can be information (e.g., highlight of a desired skill, a trending job posting, a job posting that is a hidden gem) about the job posting that is relevant to the first member.

As previously described, the job data 218 includes job statistics 217. The job statistics 217 can include a number of job applicants for the relevant job posting, and the insight presented at operation 350 is the number of applicants for the relevant job posting. Alternatively, the insight can be that the releva.nt job posting is a trending job based on the number of applicants being above a predetermined applicant threshold (e.g., 10, 20, 50). Additionally, the job score calculated at operation 320 can be further based on the number job applicants. For example, the job score increases when the number of jab applicants increases.

In some instances, the job data 218 can include a salary range for the relevant job posting, and the insight presented at operation 350 is the salary range for the relevant job posting. The salary range can be obtained from the hiring manager, or calculated using salaries of similar job postings. Additionally, the job score calculated at operation 320 can be further based on the salary range for the job posting. For example, the job score increases when the current salary of the first member is within the salary range for the job posting.

In some instances, wherein job data 218 includes career growth information for the relevant job posting, and the insight presented at operation 350 is the career growth information for the relevant job posting. For example, the career growth information can include an expected timeframe for a promotion. The expected timeframe can be obtained from the hiring manager, or calculated using profile data of other employees at the employer that have the same job title as the job posting. The number of years to the promotion can be calculated by averaging the promotion time for the other employees. Additionally, the job score calculated at operation at operation 320 can be further based on the career growth information. For example, the job score increases when the expected timeframe for a promotion decreases.

In some instances, the job statistics 217 includes a number of page views associated with the job posting over a period of time. The insight presented at operation 350 can be that the relevant job posting is a trending job posting when the number of page views associated with the job posting over the period of time is above a predetermined threshold (e.g., 50). Additionally, the job score calculated at operation 320 can be further based on the number of page views. For example, the job score increases when the number of page views for the job posting increases.

In some instances, the job data 218 includes a number of page views associated with a company page for the employer over a period of time. The insight presented at operation 350 can be that the relevant job posting is a trending job posting when the number of page views associated with the company page for the employer over the period of time is above a predetermined threshold (e.g., 200). Additionally, the job score calculated at operation 320 can be further based on the number of page views. For example, the job score increases when the number of page views for the company page increases.

In some instances, the job data 218 includes a number of job applicants for a previous job posting of the employer. The insight presented at operation 350 can be that the relevant job posting is a trending job posting when the number of job applicants for the previous job posting of the employer is above a predetermined threshold (e.g., 20). Additionally, the job score calculated at operation 320 can be further based on the number of page views for the company. For example, the job score increases when the number of page views for the company page increases.

In some instances, the job statistics 217 include a number of job applicants for the relevant job posting. The insight presented at operation 350 can be that the relevant job posting is a hidden gem job posting based on the number of applicants being below a predetermined applicant threshold (e.g., 5) and the job score being above a second predetermined score threshold, the second predetermined threshold being above the first predetermined threshold described at operation 330.

In some instances, the job data 218 include a number of hires by the employer over a period of time. The insight presented at operation 350 can be that the relevant job posting is a high growth job posting when the number of hires by the employer over the period of time is above a predetermined threshold (e.g., 10). Additionally, the job score calculated at operation 320 can be further based on the number of hires. For example, the job score increases when the number of hires for the employer increases.

In some instances, the profile data 211 of the first member include a current employer. The job score calculator 204 can determine a number of hires from the current employer by the employer of the relevant job posting. For example, the job score calculator 204 can count the members at the employer of the job posting that have moved from the current employer of the first member within the last 12 months. The job score calculated at operation 320 can be further based on the number of hires from the current employer by the employer. Additionally, the insight presented at operation 350 can be the number of hires from the current employer by the employer.

In some instances, the job data 218 includes an employer location for the employer. The job score calculator 204 can determine a member location for the first member using the member data. Additionally, the job score calculator 204 can calculate a commute time based on the employer location and the member location. Moreover, the job score calculator 204 can update the job score based on the commute time. Furthermore, the job publisher 208 can include the commute time with the presentation of the relevant job posting. For example, the insight can be the commute time.

In some instances, the relevant job posting can include a desired skill. The job score calculator 204 can determine that the first member possesses the desired skill using the member data. For example, the desired skill can be listed on the skills section in the profile page of the first member. Additionally, the job score calculator 204 can update the job score calculated at operation 320 based on the determination that the first member possesses the desired skill. Furthermore, the job publisher can include an indication that the member possesses the desired skill in the presentation of the relevant job posting.

Additionally, the variables for the job score calculations can be updated based on user input indicating the relevance of the relevant job posting presented at operation 350.

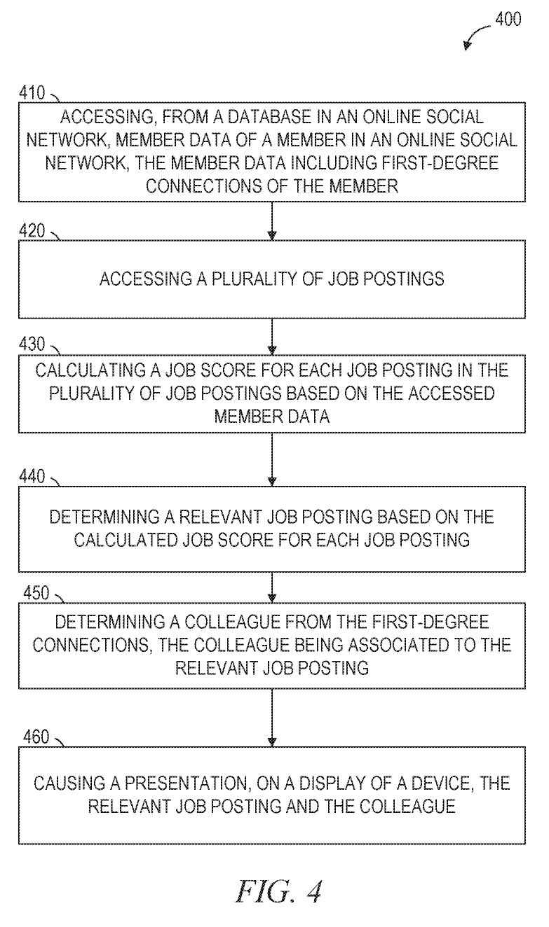

FIG. 4 is a flowchart illustrating operations of the online social network 210 in performing another method 400 for a personalized presentation of a job posting based on the member data 215 and the job data 218, according to some example embodiments. Operations in the method 400 may be performed by the network-based system 105, using the job score calculator 204, the job classifier 206, and the job publisher 208 described above with respect to FIG, 2.

At operation 410, the job publisher 208 can access, from a database in an online social network 210, member data 215 associated with the member in the online social network 210. The member data 215 can include first-degree connections of the member.

At operation 420, the job publisher 208 can access, from a job database in the online social network 210, a plurality of job postings. The database accessed at operation 420 can include the job data 218.

At operation 430, the job score calculator 204 can calculate a job score for each job posting in the plurality of job posting based on the accessed member data 215. The job score can be calculated using similar techniques described in method 300. For example, the job score calculated at operation 430 can be higher when the job posting is more relevant to the specific member. In some instances, the job score can be further based on the social graph data 212, the member activity data 213 and the job statistics 217. A processor in the server machine 110 can perform the calculation in real-time. In some instances, part of the calculation at operation 430 can be performed offline using the offline data processor 220.

At operation 440, the job publisher 208 can determine a relevant job posting based on the calculated job score for each job posting. For example, the job posting with the highest job score can be the relevant job posting. A processor in the server machine 110 can perform the calculation in real-time. In some instances, part of the calculation at operation 440 can be performed offline using the offline data processor 220.

At operation 450, the job publisher 208 can determine a second member (e.g., colleague) from the first-degree connections. The colleague can be associated with to the relevant job posting, such as a colleague currently working at the same company of the job posting. In one example, the colleague can be a previous co-worker of the specific member that currently works at the company associated with the job posting. A processor in the server machine 110 can perform the determination in real-time. In some instances, part of the determination at operation 450 can be performed offline using the offline data processor 220.

At operation 460, the job publisher 208 can cause a presentation, on a display of the device, of the relevant job posting and contact information for the colleague. The presentation can also include an insight, as previously discussed in method 300.

According to various example embodiments, one or more of the methodologies described herein facilitate the presentation of a relevant job posting. Additionally, based on the database structure illustrated in FIG. 2, the relevant job posting can be presented to a member in real-time by using the offline data processor 220 for some calculations. For example, the online social network 210 can use the offline data processor 220 for the job score calculator 204 in such a way as to allow an efficient retrieval and processing of the information in order to present the relevant job posting in real-time.

When these effects are considered in aggregate, one or more of the methodologies described herein may obviate a need for certain human efforts or resources that otherwise would be involved in generating the job score. Furthermore, computing resources used by one or more machines, databases, or devices (e.g., within the network environment 100) may similarly be reduced (e.g., by pre-determining job scores). Examples of such computing resources include processor cycles, network traffic, memory usage, data storage capacity, power consumption, and cooling capacity.

The job score calculator 204, the job classifier 206, and the job publisher 208 allow job seekers, recruiters, and market analysts to quickly find accurate information (e.g., relevant job postings) in the online social network 210. The user interface 202 provides structure for search results, which enables fast navigation and discovery.

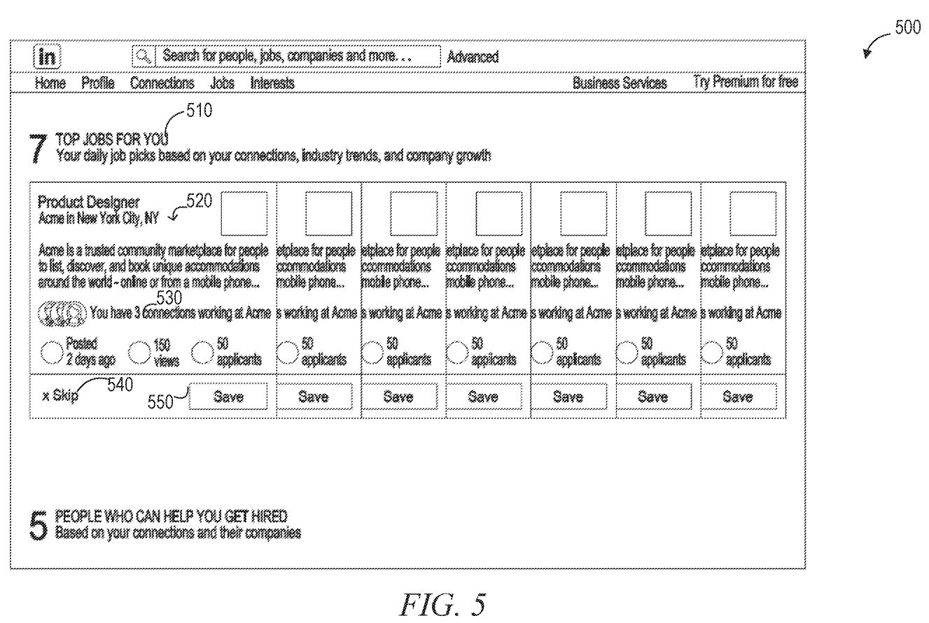

FIG. 5 is a user interface 500 for presenting top jobs to a specific member, according to some example embodiments. In some instances, the job publisher 208 can present the relevant jobs 510 to the specific member based on the job scores calculated by method 300 in FIG. 3. For example, the relevant jobs 510 can include a first job posting 520 having the highest calculated job score. Additionally, the first job posting 520 can include a first-degree connection 530 working at the company associated with the job posting 520. The first-degree connection 530 can be determined at operation 340 in FIG. 3. Additionally, the first job posting 520 can include a button for the specific user to either skip 540 or save 550 the first job posting 520. The calculation of job scores for future job postings can be modified based on the user input of either skipping or saving the first job posting 520.

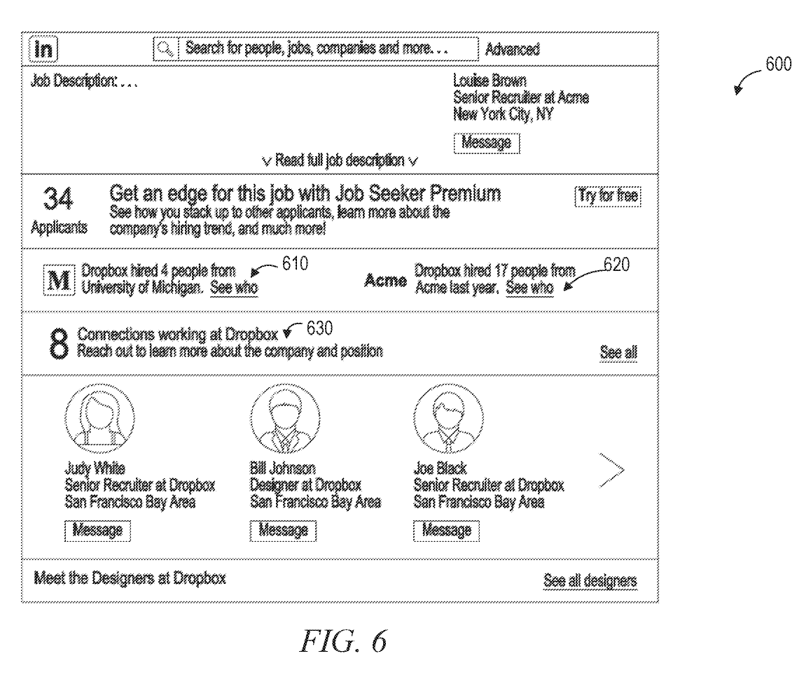

FIG. 6 is a user interface 600 for presenting a personalized job posting to a specific member, according to some example embodiments. In some instances, the job publisher 208 can present information (e.g., insight) relevant to the specific member based on the accessed member data 215. The information relevant to the specific user can include the number of employees at the company associated with the job posting that went to the same school 610, the number of employees at the company that have previously worked in the same company 620, first-degree connections that currently work at the company 630, and so on. Example techniques for determining and presenting the insight are further discussed at operation 350 in FIG. 3.

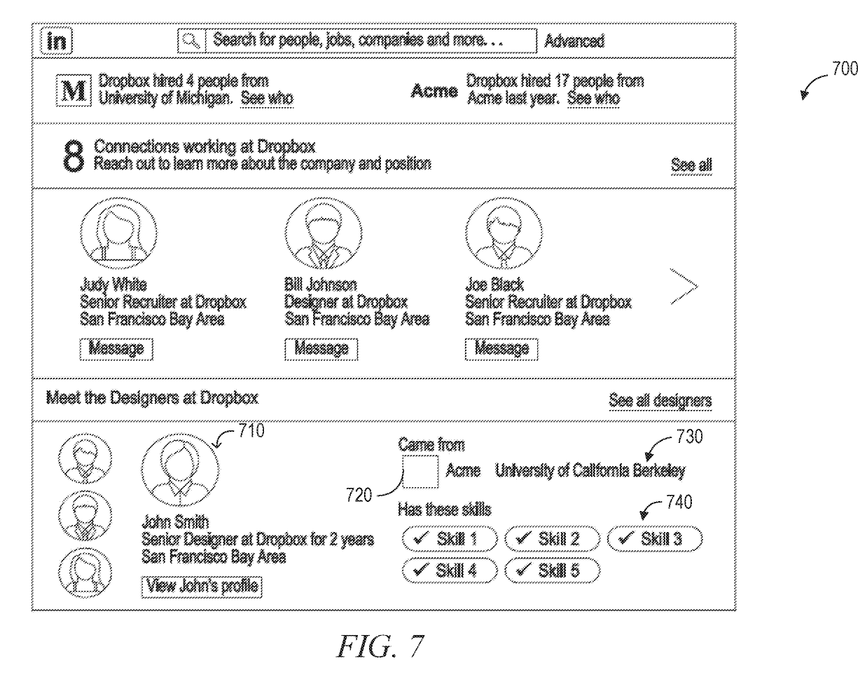

FIG. 7 is another user interface 700 for presenting a personalized job posting to a specific member, according to some example embodiments. In some instances, the job publisher 208 can present another insight relevant to the specific member based on the accessed member data. in this example, the insight to the first member can include an employee 710 working at the company associated with the job posting that has the same job title. Additionally, the job publisher 208 can present the previous employer 720 of the employee 710, school information 730 of the employee 710, and skills 740 of the employee 710.

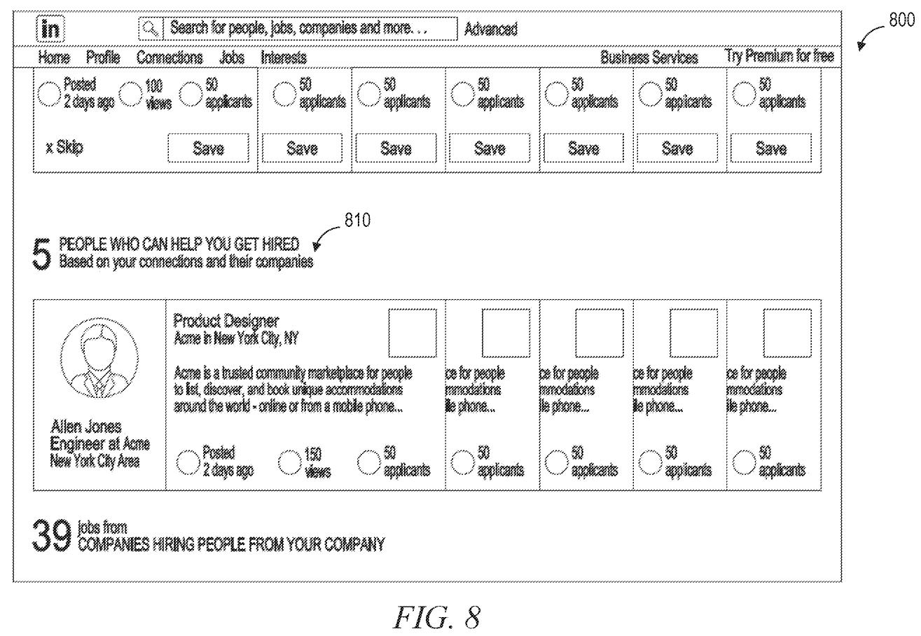

FIG. 8 is a user interface 800 for suggested contacts associated with a job posting, according to some example embodiments. In sonic instances, the job publisher 208 can also present contacts 810 that can get the specific member hired. In some instances, the second member selected at operation 340 in FIG. 3 can be one of the contacts 810. For example, the contacts 810 can include hiring managers or other members that have created a job posting on the online social network 210.

### xample Machine Architecture and Machine-Readable Medium

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example, the instructions 916 may cause the machine 900 to execute the flow diagram of FIGS. 3 and 4. Additionally, or alternatively, the instructions 916 may implement the job score calculator 204, the job classifier 206, or the job publisher 208 of FIG. 2, and so forth. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a net⁻book, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory/storage 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 912 and a processor 914 that may execute the instructions 916. The term “processor” is intended to include a multi-core processor that may comprise two or more independent processors (sometimes referred to as “cores”) that may execute instructions contemporaneously. Although FIG. 9 shows multiple processors 910, the machine 900 may include a single processor with a single core, a single processor with multiple cores (e.g., a multi-core processor), multiple processors with a single core, multiple processors with multiples cores, or any combination thereof.

The memory/storage 930 may include a memory 932, such as a main memory, or other memory storage, and a storage unit 936, both accessible to the processors 910 such as via the bus 902. The storage unit 936 and memory 932 store the instructions 916 embodying any one or more of the methodologies or firnctions described herein. The instructions 916 may also reside, completely or partially, within the memory 932, within the storage unit 936, within at least one of the processors 910 (e.g., within the processor's cache memory), or any suitable combination thereof, during execution thereof by the machine 900. Accordingly, the memory 932, the storage unit 936, and the memory of processors 910 are examples of machine-readable media. The database 115 is an example of the memory/storage 930.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 916. The term “machine-readable medium” shall also be taken to include any medium, or combination of multiple media, that is capable of storing instructions (e.g., instructions 916) for execution by a machine (e.g., machine 900), such that the instructions, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. in various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 962 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972 respectively. For example, the communication components 964 may include a network interface component or other suitable device to interface with the network 980. In further examples, the communication components 964 may include wired communication components, wireless communication components, cellular communication components, Near Field Communication (NEC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a Universal Serial Bus (USB)).

Moreover, the communication components 964 may detect identifiers or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 980 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fit network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to the devices 970. The term “transmission medium” shall be taken to include any intangible medium that is capable of storing, encoding, or carrying the instructions 916 for execution by the machine 900, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or tlinctions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application programming interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A system comprising:
a member database storing member data of a first member, the member data having profile data and social graph data of the first member;
a job database storing a plurality ofjob postings, each job posting in the plurality of job postings having job data, the job data including an employer;
one or more processors configured to:
access the member data of the first member from the member database and the plurality of job postings from the job database;
calculate a job score for each job posting in the plurality of job postings based on the profile data of the first member and the job data for each job posting;
determine a relevant job posting for the first member based on the calculated job score for each job posting in the plurality of job postings, the job score for the relevant job posting transgressing a predetermined score threshold; and
select a second member for the relevant job posting based on the social graph data of the first member and the job data for the relevant job posting, the second member being a connection of the first member that currently works at the employer of the relevant job posting; and
a user interface configured to cause a presentation, on a display of a device of the first member, of the relevant job posting and the second member.

2. The system of claim 1, wherein the profile data includes educational information, and wherein the selection of the second member is further based on th first member having a school that is common with the second member.

3. The system of claim 1, wherein the member data includes employment information, and wherein the selection of the second member is further based on the first member having a common employer with the second member.

4. The system of claim 1, wherein the job data for each job posting includes a job title, and wherein the profile data of the first member includes a current title, and wherein the job score calculated for each job posting is further based on comparing the job title with the current title.

5. The system of claim 1, wherein the job data for each job posting includes a desired degree for the job posting, and wherein the job score calculated for each job posting is further based on comparing the desired degree for the job posting and a degree obtained by the first member.

6. The system of claim 1, wherein the job data for each job posting includes a salary range, and wherein the job score calculated for each job posting is further based on comparing the salary range and the employment information of the first member.

7. The system of claim 1, wherein one or more processors are further configured to:
determine an insight associated with the want job posting based on the job data for the relevant job posting; and
wherein the presentation of the relevant job posting includes the determined insight.

8. The system of claim 7 wherein the job data includes a number of applicants for the relevant job posting, and wherein the insight is either the number of applicants for the relevant job posting or that the relevant job posting is a trending job based on the number of applicants being above a predetermined applicant threshold.

9. The system of claim 7, wherein the job data include a salary range for the relevant job posting, and wherein the insight is the salary range for the relevant job posting.

10. The system of claim 7, wherein the job data includes career growth information for the relevant job posting, and wherein the insight is the career growth information for the relevant job posting.

11. The system of claim 7, wherein the job data includes a number of page views associated with the job posting over a period of time, and wherein the insight is that the relevant job posting is a trending job posting when the number of page views associated with the job posting over the period of time is above a predetermined threshold.

12. The system of claim 7, wherein the job data includes a number of page views associated with a company page for the employer over a period of time, and wherein the insight is that the relevant job posting is a trending job posting when the number of page views associated with the company page for the employer over the period of time is above a predetermined threshold.

13. The system of claim 7, wherein the job data includes a number of applicants for a previous job posting of the employer, and wherein the insight is that the relevant job posting is a trending job posting when the number of applicants for the previous job posting of the employer is above a predetermined threshold.

14. The system of claim 7, wherein the job data includes a number of applicants for the relevant job posting, and wherein the insight is that the relevant job posting is a hidden gem job posting based on the number of applicants being below a predetermined applicant threshold and the job score being above a second predetermined score threshold.

15. The system of claim 7, wherein the job data includes a number of hires by the employer over a period of time, and wherein the insight is that the relevant job posting is a high growth job posting when the number of hires by the employer over the period of time is above a predetermined threshold.

16. The system of claim 7, wherein the profile data of the first member includes a current employer, and wherein the one or more processors are further configured to:
determine a number of hires from the current employer by the employer of the relevant job posting; and
wherein the insight is the number of hires from the current employer by the employer.

17. The system of claim 7, wherein the job data includes an employer location for the employer, and wherein the one or more processors are further configured to:
determine a member location for the first member using the member data;
calculate a commute time based on the employer location and the member location;
update the job score based on the commute time; and
wherein the presentation of the relevant job posting includes the commute time.

18. The system of claim 1, wherein the relevant job posting includes a desired skill, and wherein the one or more processors are further configured to:
determine that the first member possesses the desired skill using the member data;
update the job score based on the determination that the first member possesses the desired skill; and
wherein the presentation of the relevant job posting includes an indication that the member possesses the desired skill.

19. A method comprising:
accessing member data of a first member from a member database, the member data having profile data and social graph data of the first member;
accessing a plurality of job postings from a job database, each job posting in the plurality of job postings having job data, the job data including an employer;
calculating, using a processor, a job score for each job posting in the plurality of job postings based on the profile data of the first member and the job data for each job posting;
determining a relevant job posting for the first member based on the calculated job score for each job posting in the plurality of job postings, the job score for the relevant job posting transgressing a predetermined score threshold;
selecting a second member for the relevant job posting based on the social graph data of the first member and the job data for the relevant job posting, the second member being a first-degree connection of the first member that currently works at the employer of the relevant job posting; and
causing a presentation, on a display of a device of the first member, of the relevant job posting and the second member.

20. A non-transitory machine-readable storage medium comprising instructions that, when executed by one or more processors of a machine, cause the machine to perform operations comprising:
accessing member data of a first member from a member database, the member data having profile data and social graph data of the first member;
accessing a plurality of job postings from a job database, each job posting in the plurality of job postings having job data, the job data including an employer;
calculating a job score for each job posting in the plurality of job postings based on the profile data of the first member and the job data for each job posting;
determining a relevant job posting for the first member based on the calculated job score for each job posting in the plurality of job postings, the job score for the relevant job posting transgressing a predetermined score threshold;
selecting a second member for the relevant job posting based on the social graph data of the first member and the job data for the relevant job posting, the second member being a first-degree connection of the first member that currently works at the employer of the relevant job posting; and
causing a presentation, on a display of a device of the first member, of the relevant job posting and the second member.
